(19) United States
(12) Patent Application Publication
(10) Pub. No.: US 2009/0090849 A1
(43) Pub. Date: Apr. 9, 2009

(54) Image detectors and image detection modules

(75) Inventor: Shih-Huang Chen, Hsin-Chu (TW)

Correspondence Address: BIRCH STEWART KOLASCH & BIRCH, PO BOX 747, FALLS CHURCH, VA, 22040-0747, US

(73) Assignee: Silicon Optronics, Inc.

(21) Appl. No.: 11/984,613

(22) Filed: Nov. 20, 2007

(30) Foreign Application Priority Data
Oct. 9, 2007 (TW) 96137797

(51) Int. Cl. G01J 3/50

(52) U.S. Cl. 250/226

(57) ABSTRACT

An image detector comprising a first detection array and a second detection array. The first detection array comprises a plurality of first detection units disposed sequentially, and each first detection unit comprises a plurality of first detection cells. In each first detection unit, the first detection cells respectively generate a plurality of first signals, and the first signals respectively represent different color information. The second detection array comprises a plurality of second detection units disposed sequentially, and each second detection unit comprises at least one second detection cells. Each second detection cell generates a second signal, and each second signal represents specific color information.

### BACKGROUND OF THE INVENTION

1. Field of the Invention

The invention relates to an image detector, and more particularly to an image detector comprising multi-mode detection arrays.

2. Description of the Related Art

FIG. 1 shows a conventional color linear image detection module. Referring to FIG. 1, the color linear image detection module 1 comprises a red light source RL, a green light source GL, a blue light source BL, a light guide 10, a rod lens 11, and a detection array 12. The detection array 12 comprises a plurality of detection units 120₁-120_{N}. The red light source RL, the green light source GL, the blue light source BL sequentially provide light to an object through the light guide 10. According to the reflected light from the object, the detection array 12 generates image data. Since a motor drives the color linear image detection module 1 to move, color fragmentation appears in the detected image. Moreover, since red light source RL, the green light source GL, the blue light source BL is sequentially switched to provide light, there is an extra memory to store image data previously generated, and then color data of one point of the object is obtained. Referring to FIG. 2, a high logic level of a driving signal LEDR drives the red light source RL to emit light, and the detection units 120₁-120_{N} respectively generate red image data IDR₁-IDR_{N}. A high logic level of a driving signal LEDG drives the green light source GL to emit light, and the detection units 120₁-120_{N} respectively generate green image data IDG₁-IDG_{N}. A high logic level of a driving signal LEDB drives the blue light source BL to emit light, and the detection units 120₁-120_{N} respectively generate blue image data IDB₁-IDB_{N}. A transfer gate signal TG is used to indicate a reading operation of image data. According to timing of the driving signals LEDR, LEDG, and LEDB, an extra memory is required to store image data previously generated. When red image data, green image data, and blue image data of one point has been generated, color image data is obtained.

FIG. 3 shows another conventional color linear image detection module. Referring to FIG. 3, the color linear image detection module 3 comprises a white light source WL, a light guide 30, a rod lens 31, and a detection array 32. The detection array 32 comprises a plurality of detection unit 320₁-320_{N}. The white light source WL provides light to an object through the light guide 30. According to the reflected light from the object, the detection array 32 generates image data. Each detection unit comprises three detection cells, a red detection cell, a green detection cell, and a blue detection cell in FIG. 3. For example, the detection cell 320₁ comprises a red detection cell RC₁, a green detection cell GC₁, and a blue detection cell BC₁. Referring to FIG. 4, a high logic level of a driving signal LEDW drives the white light source WL to emit light, and the red detection cell, the green detection cell, and the blue detection cell of each detection unit respectively generate red image data, green image data, and blue image data. For example, the red detection cell RC₁, the green detection cell GC₁, and the blue detection cell BC₁ of the detection unit 320₁ respectively generate red image data IDR₁, green image data IDG₁, and blue image data IDB₁. A transfer gate signal TGW is used to indicate a reading operation of image data. According to the image data in FIG. 4, the color linear image detection module 3 reads out a set of red image data, green image data, and blue image data sequentially and then obtain color image data of one point. If gray-level image data of one point is obtained by the three detection cells of one detection unit in the structure, image resolution of the point is degraded.

### BRIEF SUMMARY OF THE INVENTION

An exemplary embodiment of an image detector is provided. The image detector comprises a first detection array and a second detection array. The first detection array comprises a plurality of first detection units disposed sequentially, and each first detection unit comprises a plurality of first detection cells. In each first detection unit, the first detection cells respectively generate a plurality of first signals, and the first signals respectively represent different color information. The second detection array comprises a plurality of second detection units disposed sequentially, and each second detection unit comprises at least one second detection cells. Each second detection cell generates a second signal, and each second signal represents specific color information.

An exemplary embodiment of an image detection module for detecting an image of an object is provided. The image detection module comprises a first detection array, a second detection array, a control unit, and an image processing unit. The first detection array comprises a plurality of first detection units disposed sequentially, and each first detection unit comprises a plurality of first detection cells. In each first detection unit, the first detection cells respectively generate a plurality of first signals, and the first signals respectively represent different color information. The second detection array comprises a plurality of second detection units disposed sequentially, and each second detection unit comprises at least one second detection cells. Each second detection cell generates a second signal, and each second signal represents specific color information. The control unit provides a control signal to selectively drive the first detection array to generate the first signals or drive the second detection array to generate the second signals according light from the object. The image processing unit generates the image of the object according to the first signals or the second signals.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional color linear image detection module;

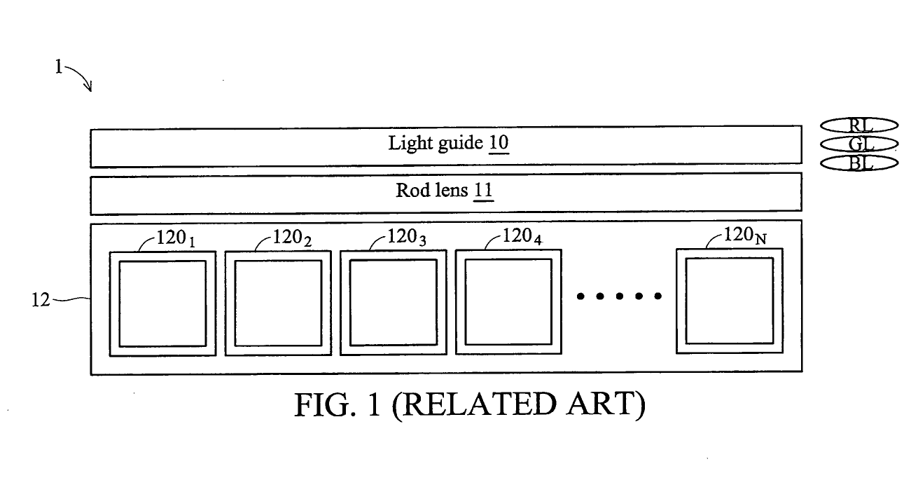

FIG. 2 is a timing chart of the driving signal, the transfer gate signal, and the data signals of FIG. 1;

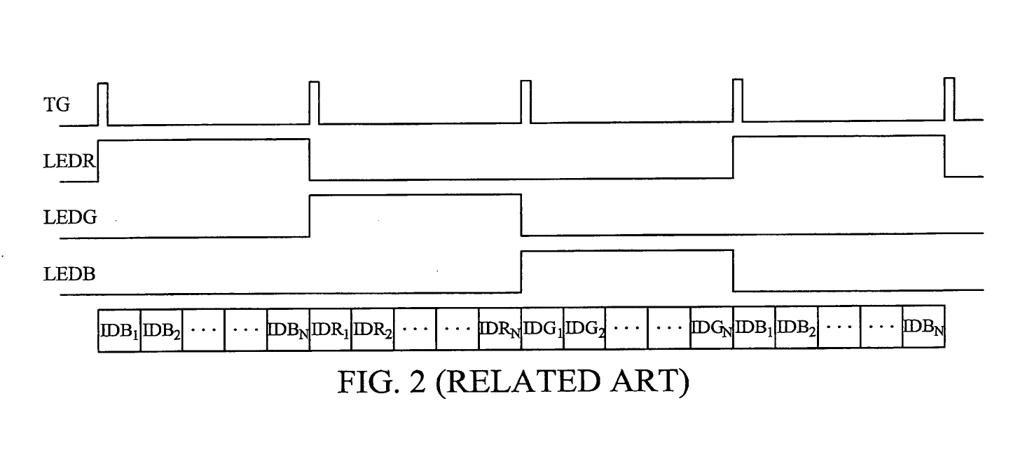

FIG. 3 shows another conventional color linear image detection module;

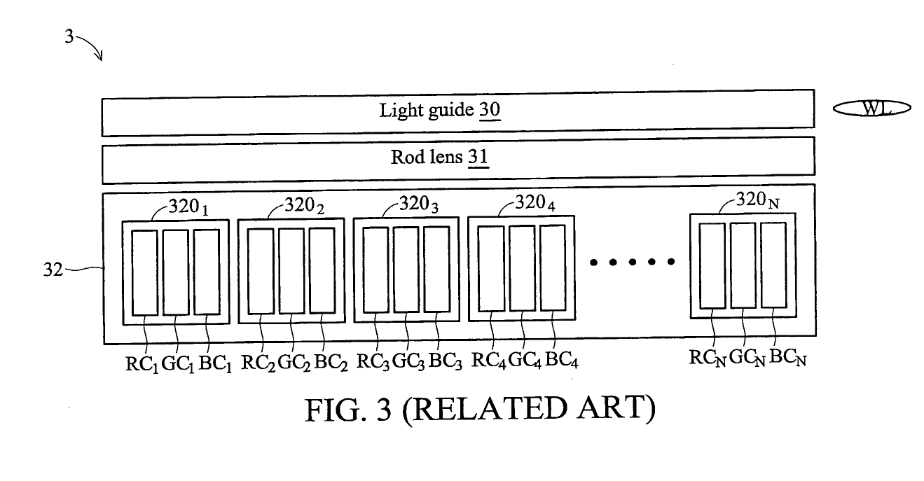

FIG. 4 is a timing chart of the driving signal, the transfer gate signal, and the data signals of FIG. 3;

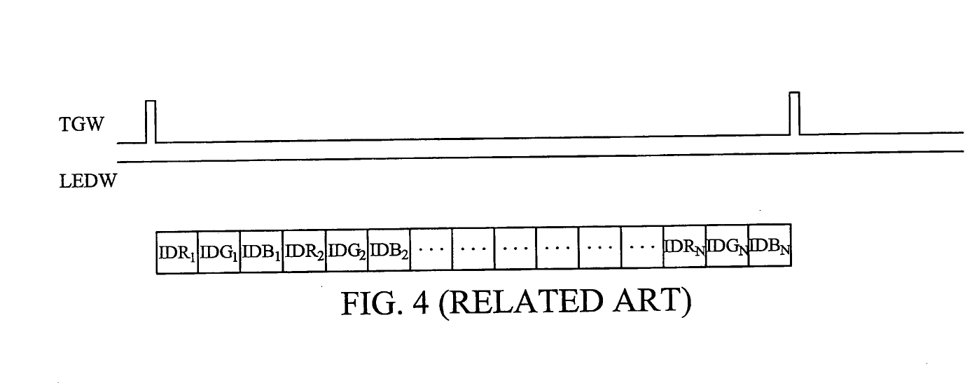

FIG. 5 shows an exemplary embodiment of an image detection module according to the invention;

FIG. 6 is a timing chart of the driving signal, the transfer gate signal, and the data signals of FIG. 5;

FIG. 7 shows another exemplary embodiment of an image detection module according to the invention;

FIG. 8 is a timing chart of the driving signal, the transfer gate signal, and the data signals of FIG. 7;

FIG. 9 shows an exemplary embodiment of a structure of the first detection cells according to the invention; and

FIG. 10 shows another exemplary embodiment of an image detection module according to the invention.

### DETAILED DESCRIPTION OF THE INVENTION

The following description is the best-contemplated mode of carrying out the invention. This description is made for the purpose of illustrating the general principles of the invention and should not be taken in a limiting sense. The scope of the invention is best determined by reference to the appended claims.

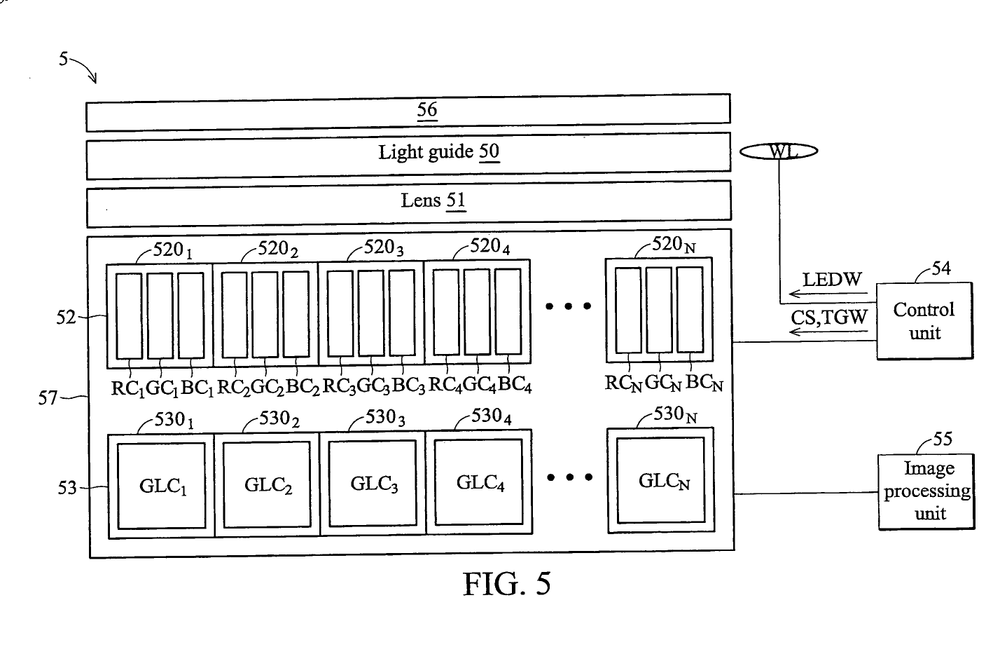

Image detection modules are provided. In an exemplary embodiment of an image detection module in FIG. 5, an image detection module 5 comprises white light source WL, a light guide 50, a lens 51, a control unit 54, an image processing unit 55, and an image detector 57. The image detector 57 comprises a first detection array 52 and a second detection array 53. The white light source WL provides light to an object 56 through the light guide-50. The reflected light from the object 56 is provided to the first detection array 52 and the second detection array 53 through the lens 51. The control unit 54 provides a control signal CS to selectively drive the first detection array 52 or the second detection array 53.

Referring to FIG. 5, the first detection array 52 comprises a plurality of first detection units 520₁-520_{N} disposed sequentially. Each first detection unit comprises a plurality of first detection cells. For example, the first detection unit 520₁ comprises three detection cells, that are a red detection cell RC₁, a green detection cell GC₁, and a blue detection cell BC₁. The second detection array 53 comprises a plurality of second detection units 530₁-530_{N} disposed sequentially and corresponding to the first detection units respectively. Each second detection unit comprises at least one second detection cell. In the embodiment of FIG. 5, each second detection unit comprises one second detection cell For example, the second detection unit 530₁ comprises a gray-level detection cell GLC₁. In some embodiments, the second detection units 530₁-530_{N} do not correspond to the first detection units 520₁-520_{N}, and each second detection unit corresponds to two adjacent first detection units.

The image detection module 5 has two detection modes, and operations of the two detection modes will be described later in detailed.

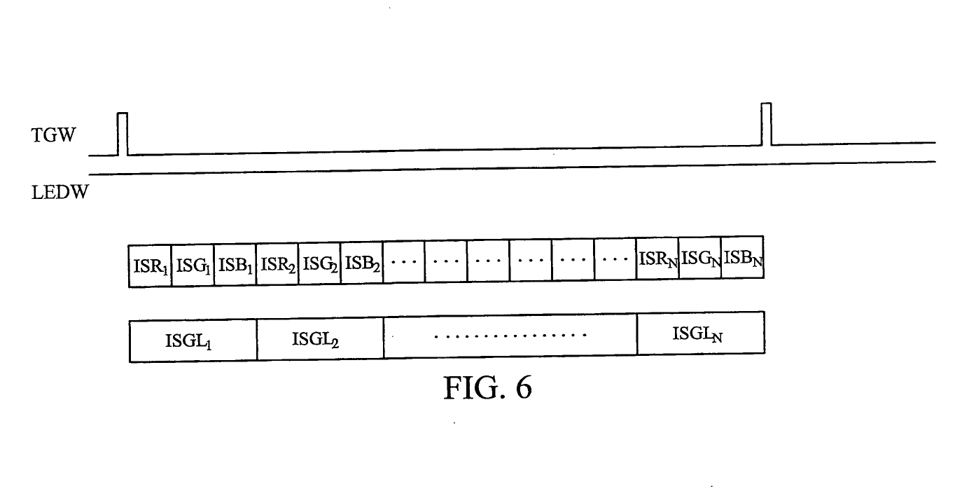

Referring to FIGS. 5 and 6, the control unit 54 provides a driving signal LEDW to the white light source WL, wherein a high logic level of the driving signal LEDW drives the white light source WL to emit light. In a first detection mode, the control unit 54 provides the control signal CS to drive the first detection array 52. The first detection array 52 generates a plurality of signal signals according to the reflected light from the object 56. In the embodiment of FIG. 5, for each first detection unit, according to the reflected light from the object 56, the red detection cell, the green detection cell, and the blue detection cell generate respective first signals, that are a red image signal ISR₁, a green image signal ISG₁, and a blue image signal ISB₁. The red image signal ISR₁, the green image signal ISG₁, and the blue image signal ISB₁ represent different color information, respectively being red, green, and blue. The control unit 54 further provides a transfer gate signal TGW to indicate a reading operation of image signals.

In the first detection mode, the image processing unit 55 receives the red image signal ISR₁, the green image signal ISG₁, and the blue image signal ISB₁ and generates an image of one point of the object 56 in colors.

Referring FIGS. 5 and 6, in a second detection mode, the control unit 54 provides the control signal CS to drive the second detection array 53. The second detection array 53 generates a plurality of second signals according to the reflected light from the object 56. According to the embodiment of FIG. 5, in each second detection unit, the gray-level detection cell generates one second signal according to the reflected light from the object 56. For example, in the second detection unit 530₁, the gray-level detection cell GLC₁ generates a gray-level image signal ISGL₁ according to the reflected light from the object 56. The gray-level image signal ISGL₁ represents gray-level information (specific color/brightness information), that is, gray-level/brightness degree of the object 56.

In the second detection mode, the image processing unit 55 receives the gray-level image signal ISGL₁-ISGL_{N} to generate the image of one point of the object 56 in gray levels.

In the embodiment of FIG. 5, each first detection unit generates an image of one point of the object 56 in colors, and the each second detection unit generates an image of one point of the object 56 in gray levels. Thus, resolution of the first detection array 52 is equal to resolution of the second detection array 53.

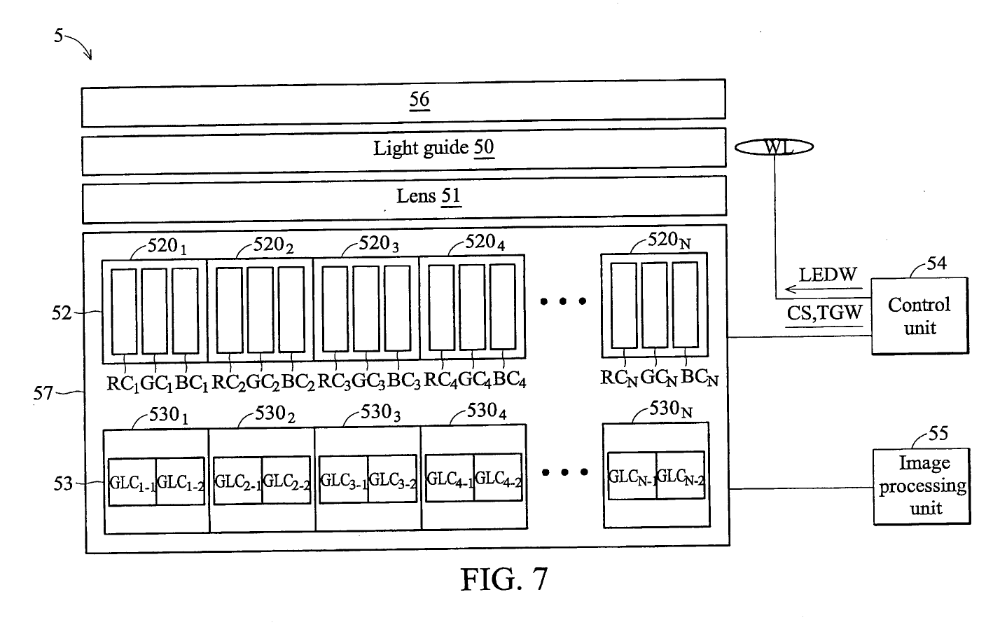

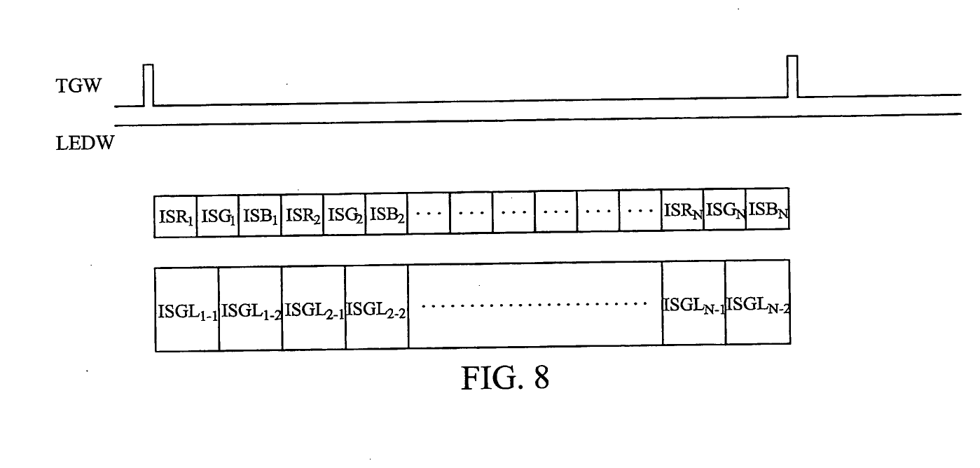

In some embodiments, by increasing the number of gray-level cells in each second detection unit, the gray-level resolution is increased. In other words, each second detection units comprises at least two second detection cells. For example, the second detection unit 530₁ comprises two gray-level detection cells GLC₁₋₁ and GLC₁₋₂, as shown in FIG. 7. Referring to FIGS. 7 and 8, when the image detection module 5 is the second detection mode, the gray-level detection cells GLC₁₋₁ and GLC₁₋₂ of the second detection unit 530₁ respectively generates gray-level image signals ISGL₁₋₁ and ISGL₁₋₂. The image processing unit 55 receives the gray-level detection cells GLC₁₋₁ and GLC₁₋₂ . . . GLC_{N-1} and GLC_{N-2} from the second detection array 53. The image processing unit 55 generates a whole image of the object of the object 56 in gray levels, wherein each gray-level signal is used to generate an image of one point of the object 56 in gray levels. Referring to FIG. 8, each first detection unit generates an image of one point of the object 56 in colors, and the each second detection unit generates images of two points of the object 56 in colors. The resolution of the first detection array 52 is half of the resolution of the second detection array 53.

According to description above, the image detection module 5 detects an image of the object 56 selectively by a color mode or a gray-level mode. When the image detection module 5 generates the image of the object 56 by the color mode, the image processing unit 55 reads out one set of the red image signal ISR₁, the green image signal ISG₁, and the blue image signal ISB₁ sequentially to obtain an image of one point of the object 56 in colors. Thus, a color image of one point of the object 56 can be obtained in a short period of time, and there is not requirement for usage of additional memory.

Moreover, if each second detection unit comprises at least two second detection cells, gray-level image resolution is increased when the image detection module 5 is in gray-level mode.

In the embodiment of FIG. 7, the resolution of the first detection array 52 is half of the resolution of the second detection array 53. However, in other embodiments, according system requirements, the resolution of the first detection array 52 is equal to or different from the resolution of the second detection array 53.

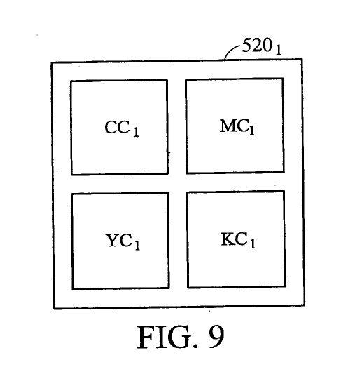

In the embodiment of FIG. 5, each first detection unit of the first detection array 52 comprises a red detection cell, a green detection cell, and a blue detection cell which generate first signals respectively indicating red, green, and blue of different color information. In some embodiments, as shown in FIG. 9, each first detection unit comprises four first detection cells, a cyan detection cell CC₁, a magenta detection cell MC₁, a yellow detection cell YC₁, and a black detection cell KC₁, which respectively represent cyan (C), magenta (M), yellow (Y), black (K) of different color information. The processing unit 55 reads out one set of a cyan image signal, a magenta image signal, a yellow image signal, and a block image signal sequentially to obtain an image of one point of the object 56 in colors.

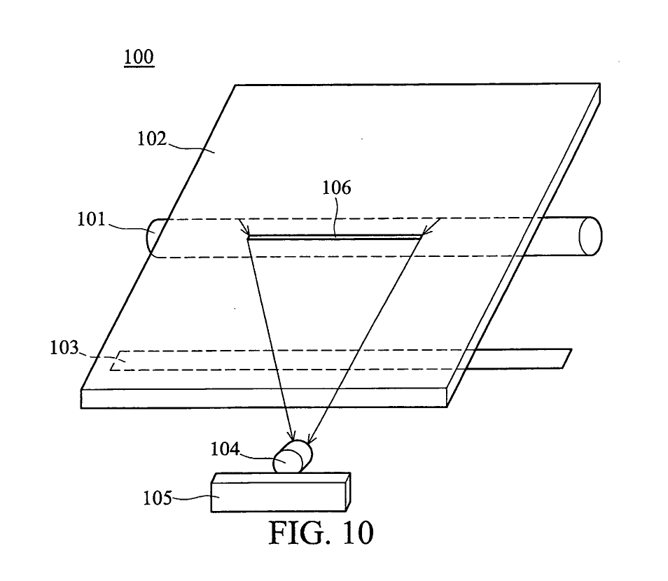

In description above, a contact image sensor (CIS) system is given as an example to serve as the image detection module of the embodiments. In other embodiments, the image detection arrays with multi-mode of the embodiments can be applied in a charge couple device (CCD) system. As shown in FIG. 10, the image detection module is a CCD system and comprises a light source 101, a glass board 102, a reflection mirror 103, a lens 104, and an image detector 105. The image detector 105 comprises the first detection array 52 and the second detection array 53 in above embodiments. An object 106 is disposed under the glass board 102. The light source 101 provides light to the object 106. The reflected light from the object 106 is provided to the first detection array 52 and the second detection array 53 through the reflection mirror 103 and the lens 104. The light source 101 and the first detection array 52 and the second detection array 53 of the image detector 105 are also controlled by the control unit 54 and the image processing unit 55. In this embodiment, the light source 101 provides white light.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image detector comprising:
a first detection array comprising a plurality of first detection units disposed sequentially, and each first detection unit comprising a plurality of first detection cells, wherein in each first detection unit, the first detection cells respectively generate a plurality of first signals, and the first signals respectively represent different color information; and
a second detection array comprising a plurality of second detection units disposed sequentially, and each second detection unit comprising at least one second detection cells, wherein each second detection cell generates a second signal and each second signal represents specific color information.

2. The image detector as claimed in claim 1, wherein when each first detection unit comprises three first detection cells, the first signals respectively represent red, green, and blue of different color information for each first detection unit.

3. The image detector as claimed in claim 2, wherein the specific color information is gray-level degree.

4. The image detector as claimed in claim 2, wherein each second detection unit comprises two second detection cells, and each second detection cell generates the second signal representing gray-level degree.

5. The image detector as claimed in claim 1, wherein when each first detection unit comprises four first detection cells, the first signals respectively represent cyan (C), magenta (M), yellow (Y), black (K) of different color information for each first detection unit.

6. The image detector as claimed in claim 5, wherein the specific color information is gray-level degree.

7. The image detector as claimed in claim 1, wherein each second detection unit comprises two second detection cells, and each second detection cell generates the second signal representing gray-level degree.

8. The image detector as claimed in claim 1, wherein resolution of the first detection array is equal to resolution of the second detection array.

9. The image detector as claimed in claim 1, wherein resolution of the first detection array is different from resolution of the second detection array.

10. The image detector as claimed in claim 1, wherein resolution of the first detection array is half of resolution of the second detection array.

11. An image detection module for detecting an image of an object, comprising:
a first detection array comprising a plurality of first detection units disposed sequentially, and each first detection unit comprising a plurality of first detection cells, wherein in each first detection unit, the first detection cells respectively generate a plurality of first signals, and the first signals respectively represent different color information;
a second detection array comprising a plurality of second detection units disposed sequentially, and each second detection unit comprising at least one second detection cells, wherein each second detection cell generates a second signal, and each second signal represents specific color information;
a control unit providing a control signal to selectively drive the first detection array to generate the first signals or drive the second detection array to generate the second signals according light from the object; and
an image processing unit generating the image of the object according to the first signals or the second signals.

12. The image detection module as claimed in claim 11, wherein when the control provides the control signal to drive the first detection array, the first detection array generates the first signals according to the light from the object.

13. The image detection module as claimed in claim 12, wherein the image processing generates the image of the object according the first signals in colors.

14. The image detection module as claimed in claim 11, wherein when the control provides the control signal to drive the second detection array, the second detection array generates the second signals according to the light from the object.

15. The image detection module as claimed in claim 12, wherein the image processing generates the image of the object according the second signals in gray levels.

16. The image detection module as claimed in claim 11, wherein the control unit provides a transfer gate signal for indicating a reading operation of the first signals and the second signals.

17. The image detection module as claimed in claim 11 further comprising:
a light source providing light to the object;
a light guide, wherein the light from the light source is provided to the object through the light guide; and
a lens, wherein the light reflected from the object is provided to the first detection array and the second detection array through the lens.

18. The image detection module as claimed in claim 11 further comprising:
a light source providing light to the object;
a reflection mirror; and
a lens, wherein the light reflected from the object is provided to the first detection array and the second detection array through the reflection mirror and the lens.
